(19) United States
(12) Patent Application Publication
(10) Pub. No.: US 2016/0034875 A1
(43) Pub. Date: Feb. 4, 2016

(54) METHOD TO DISBURSE FUNDS USING RETAILER'S POINT OF SALE SYSTEM

(71) Applicants: Kimberly Stevens, Camarillo, CA (US); Amir Marandy, Woodland Hills, CA (US); Quang Minh Ngo, Marina, CA (US); Derrick Earl Morris, Sr., Prunedale, CA (US)

(72) Inventors: Kimberly Stevens, Camarillo, CA (US); Amir Marandy, Woodland Hills, CA (US); Quang Minh Ngo, Marina, CA (US); Derrick Earl Morris, Sr., Prunedale, CA (US)

(73) Assignee: QR KASH INC., Camarillo (US)

(21) Appl. No.: 14/450,243

(22) Filed: Aug. 3, 2014

(51) Int. Cl. G06Q 20/20; G06Q 20/40; G06Q 20/10

(52) U.S. Cl. CPC G06Q 20/202; G06Q 20/108; G06Q 20/4012

(57) ABSTRACT

A unique and novel method is disclosed whereby funds are made available in a secure fashion to people who do not have bank accounts but want the security of a direct deposit system. Employers receive the benefit of the reduction in paperwork and increase in safety, and the employee receives also safety in obtaining funds at greatly reduced costs and fees to the employee. This system uniquely operates using the return or refund portion of a retailers POS system at the cash register or through their customer service desk. This method also works with people wanting to transfer funds to others in a safe manner with reduced fees. This unique method uses a single transaction process to reduce complicated back end systems hardware and architecture to calculate remaining balances. Vendors benefit from this system in that they are able to accomplish the number one goal of any retailer: getting the customers into their stores.

### CROSS-REFERENCE TO RELATED APPLICATIONS

There are not any applications that have been filed in the United States nor in any international country that are related to this application.

### FIELD OF THE INVENTION

The field of this particular application for this invention is the financial industry and generally relates to that transfer of funds from those who have earned or received money to those institutions where people generally spend the money to purchase items of necessity or items that they desire to have. This method is not limited to the disclosure herein, but rather this application discloses one way to practice this invention.

### BACKGROUND OF THE INVENTION

This invention is principally targeted at the millions of people who receive money in the form of payroll, gifts or in payment for services through a check or other form of remittance, which requires the receiver to claim their money through another institution. It is estimated that more than 10% of the working US population does not have permanent banking relations, which is estimated to be more than 13 million people. These people, without bank accounts, cause problems not only for themselves but also for the issuers of checks and other remittances. The chance that these people will lose or have stolen or will have these checks or remittances forged, because they are not kept in the normal stream of financial commerce, is greatly increased. It would be a great benefit to the employer, to be able to pass on to the employee without banking relations, a service whereby the employees hard earned money will be transferred to them in a usable fashion and form, similar to the ease and safety of the direct deposit system.

When these people, who do not have bank accounts or do not wish to have a bank account, are forced to “cash” their checks or remittances, they are often forced to pay high premiums to those who will turn the checks into money, usually keeping 10-12% of the checks value. The television and the Internet are replete with companies more than willing to take a chance to cash an employee's check for exorbitant fees and costs. Furthermore the employers are is also placed a greater burden for those without bank accounts.

The cost for the employer to replace lost, damaged or otherwise unusable checks is a very large burden. Not only did they need to interface with their banking relations to stop payment on the checks, check for fraudulent cashing of the check or checking to make sure that the employee is not lying to them, but the employer now also has the burden of preparing a new remittance to protect themselves from possible violations of labor laws. The employer who issue the checks are also at disadvantage when they create payroll checks as they have the tremendous costs in the preparation, distribution and accounting for the payroll checks, and face many more accounting issues when checks are lost, stolen or forged. In other instances, the employer usually places the burden upon the payee of the check to prove that they have not already received any benefit for the lost, stolen or forged payroll checks, and often they are unable to meet that burden, so they could go without pay.

There are many reasons why people do not have bank accounts. Some people can not receive bank accounts due to identification issues and some people do not want to have their identities known. The anonymity of the payee is something that is protected by them. Due to the high state of fraud and identity theft, many people prefer not to have their identities possibly compromised and giving all of their pertinent information to a banking institution. In the current state of the art for the industry, there are many companies such as Paychexs, ADP, QuickBooks and others that automatically process and deposit payroll funds earned by the payee into the payee bank account. That does not benefit those that do not have bank accounts. The current system benefits those that have bank accounts and penalizes those, through exorbitant costs and fees, without bank accounts.

With this system disclosed in the present invention, an employee's pay can be transferred or deposited to a retail establishment, such as a big box retail store, who already has in place, a financial system which deals with large sums of cash. The benefit to the employee is that their pay has all of the benefits of being “direct deposited” and the employer has the safety of the direct deposit system as well. The benefit to the retail establishment, is that they have a customer who is going into their store who will now have the financial means to purchase items in their store. Even though this system is focused about the employer/employee payment system, there is nothing that focuses or limits the application to only a payroll-based system. There are obvious variants of this principle, such as utility payments, gift cards and any other payment where the receiver is to be in receipt of a certain sum of money, given by another, for a specific use and/or location of use. This system would also work with legacy systems such as Paychexs, ADP, or other payroll processing systems, whereby rather than creating a direct deposit, the present invention, as a system, is allowed to interface and receive the funds. It is also evident that this system can be used for people to send money to a recipient whereby the sender can be assured of it's safety and it's correct and proper use, such as a parent sending money to their kid in college, where the parent can direct money to a particular retailer or grocery store.

The prior art has many examples of a direct deposit model of payroll distribution, such as the Paychex and ADP style of system, including those systems where payroll can be turned into ATM style debit cards. Without a bank account, these people can not take advantage of the system and the employer can not take advantage of their benefits. Any form of payment, where the employee does not have direct deposit, burdens both the employee and the employer. People are even able to have their tax returns direct deposited, if they have banking relations.

Present state of the art includes the ability of a direct deposit style of system, where the employee tells the employer to have his payroll funds be paid to a third party (Vasic, WO2001059663A1) but this system does not involve the employee receiving the funds as in the present invention. In U.S. Pat. No. 7,941,351 issued to Rosenfeld et al on May 10, 2011, the employee is able to request his direct deposit to a specific recipient while an accountant is utilized to watch over the system. Both of these patents highlight uses of the direct deposit type of system for those with bank accounts.

This prior art system does not relieve the employee of the problem of not having a bank account, and these cards carry many fees and costs to both the employer and employee including costs and fees for non-usage after a certain amount of time, cost for the employer and/or the employee to obtain the cards and the burden placed on the retailer who loses a percentage of the sale to fees. The reasoning for this is that when funds are not used, there is an overhead cost for maintaining the bank accounts that hold this money and accounting for this money over periods of time create accounting issues and Federal regulation problems for “abandoned” funds. There are also the overhead costs for maintaining a networked computer for the large back-end processing of keeping track of the remaining funds all of the individual cards and the multiple instances where fraud could occur. It would also be obvious that a retailer would be excited to have a system whereby their sales are not burdened by the fees from the credit card industry.

For those without bank accounts, ATM or debit card creation is an option. U.S. Pat. No. 8,015,085 issued to Blagg et al on Sep. 6, 2011, an employee can have his payroll funds transferred to a third party intermediary who will create ATM or debit style “payroll” cards. This system is also able to allocate child support obligations to the obligee through a direct payroll deduction to an ATM/Debit style card. Another system allows for the user to input their paycheck into a check reader, which then creates an ATM/Debit card, as disclosed in U.S. Pat. No. 6,848,611 issued to Higgins on Feb. 1, 2005. These patents are typical of the type of transactions that are afforded to people without banking relations.

Common issues with these styles of systems is the tremendous backend processing that is necessary to maintain the system and to create a massive audit trail whenever the ATM/Debit cards are used and to maintain the proper amount of credit on the cards, the cancelled sales and returns and the problems with theft and fraud. Once someone steals a pre-loaded ATM/Debit card, there is no identification that the store can receive to validate who is using the card and if the card has been stolen until it is reported stolen.

### SUMMARY OF THE INVENTION

This invention is targeted at those who do not have existing bank accounts for whatever reason, but is not limited to only people participating in this invention. College students, who receive a weekly “allowance” or anybody wanting to send money to another person can use this system, whereby the convenience, safety and ease of use benefits the sender and the receiver. This invention provides a service whereby a person can request that their money be sent to another individual to be received at a vendor's establishment, such as a retail store, kiosk or any vendor that processes money. This invention can also provide a service whereby a company can request that a person's payroll by received by that person at a vendor's establishment, similar to a direct deposit of one's payroll check.

This invention uniquely uses the return or refund transactional side of a retailer's point of sale system (POS) to create a traceable, auditable transaction on the retailer's system and is easily transmitted by the host system using a matrix or 2 dimensional barcode to the intended recipient that is a unique identifier to the transaction. The matrix barcode that is used has the capability of holding and transmitting more than 4000 alpha-numeric characters in a single barcode, and can include parity and data encryption to secure the data and the user. Basic matrix barcodes, such as the QR code, SPARQCode, Aztec and Maxi-Code, all of which are in the public domain or whose owners are not choosing to enforce their patent rights, and such codes are license and royalty free.

Since the refund or return transaction is common to most all POS systems, the ease of integration into a legacy system of a retailer is greatly increased, as this method creates a “sale” or credit in the retailer's system that is equivalent to the requester's amount of money for the transaction.

The requester, be it an individual or employer, communicates their desire to have their money deposited with a particular retail establishment, for example ABC Stores. The host system creates a transaction identifier that is cross-referenced with an amount of money, destination and other pertinent information. The system host banking institution receives or has transferred thereto the money, as the system notifies the retailer that a transaction is forthcoming. Once the money is received into the host system's banking institution, the host creates a transactional code which is translated into a matrix barcode which is sent to the proposed recipient of the money via a variety of communication means. Safety is added to this transaction where the requester communicates a personal identification number (PIN) to the recipient, outside of the host system, where theft of the matrix barcode is worthless without the PIN.

At this point the money is transferred to the retail establishment's banking institution. It is recorded in their financial system as a “sale” for the amount of money the receiver is due. The recipient goes to the retail establishment and either shops for goods and checks out using the matrix barcode as the form of payment, or goes to the customer service or returns desk and receives his money to be used as they wish. The retailer notifies the host system that the “refund” has been verified and the transaction is closed.

This is a single use transaction of the code and for the entire transaction. There is no need for massive backend processing to maintain the correct amount of funds that remain during multiple transactions. The retailer receives percentage fee for this transaction and depending on how long it takes for the receiver to pick up their money, the retailer is able to receive the benefit of the money's “float” in their financial institution. As this is a single use transaction, there is no need for the complexities of tracking each use of the code along with decrementing the value of the code with each retail transaction. And due to algorithms in the system, each transactional code is unique and will never repeat. The retailer is able to have a customer enter their store, which is the goal of every retailer, and possibly receive the added benefit of the receiver spending their money at the store.

As an additional benefit, it is possible for the host system to stage multiple releases of transaction codes based upon a single deposit. This can be done either using multiple retail establishments or set calendar releases of a particular amount. For example, if employee Smith, wants his payroll check of $1000 to be “deposited”, with $250 going to in retailer Number 1, $500 to retailer number 2 and $250 to retailer number 3. Smith will receive a unique matrix barcode for each establishment. In a non-payroll example, Mr. Smith wants his son in college to get food at the market but does not trust him with a month's worth of money, so Mr. Smith deposits $400 into the host system with $100 releases to retailer establishment Market, in 4 weekly increments. His son will receive 4 different transaction codes in 7 days intervals.

The matrix barcode is transmitted to the receiver through a variety of transmission means, including but not limited to, electronic mail, text, cell phone application, social media chats, electronic greeting cards and gift certificates and used on vendor websites for shopping cart items and through a web based webpage portal that will include all “active” barcodes and a history of usage of previous bar codes. The receiver will be able to cancel or report missing or theft of a code through the webpage portal or cell phone application.

It is an object of this method to use existing electronic message transmission means, financial methods and cash flow and customer service methods that are common in the retail industry. It is an object of this invention not to reinvent the wheel, but is to use the wheel for the betterment of the retailer, payer and the payee.

It is an object of this invention to create a method whereby a single identifier displayed and transmitted as matrix barcode, that is unique to the individual recipient's transactions, can identify a financial transaction. It is another object of this invention to create an identifier that has only a single use and that is not easily duplicated, that is random to the recipient and that pay or credit the retail establishment directly, thereby reducing the chance of theft. This single identifier, which is unique to the recipient is difficult to forge and must be independently verified and due to its single use will prevent the occurrence of fraud and other nefarious means to steal the payee's money.

There is a need to keep a shorter expiration date on payroll and other remittances. Normal expiration dates on checks can run up to six months. There needs to be a system that reduces the time that a payee has to access the funds and use them before they are turned into a bank account. This reduced amount of time helps not only they payee but also that payer in that they have a reduced amount of time to worry about lost, stolen, or forged checks. It is an object of this invention to protect the payee and the payer from checks and remittances that have a long expiration date.

It is an object of this invention to create a method whereby the payee can receive their hard earned money that they had been paid in a manner that does not force them into the banking industry which is ripe with fees and costs that these lower income earners cannot afford. It is also an object of this invention to create a method and a system where people without banking relations can safely transfer their monies into institutions that can safeguard this money and can provide a service to these payees.

### BRIEF DESCRIPTION OF SEVERAL VIEWS OF THE DRAWINGS

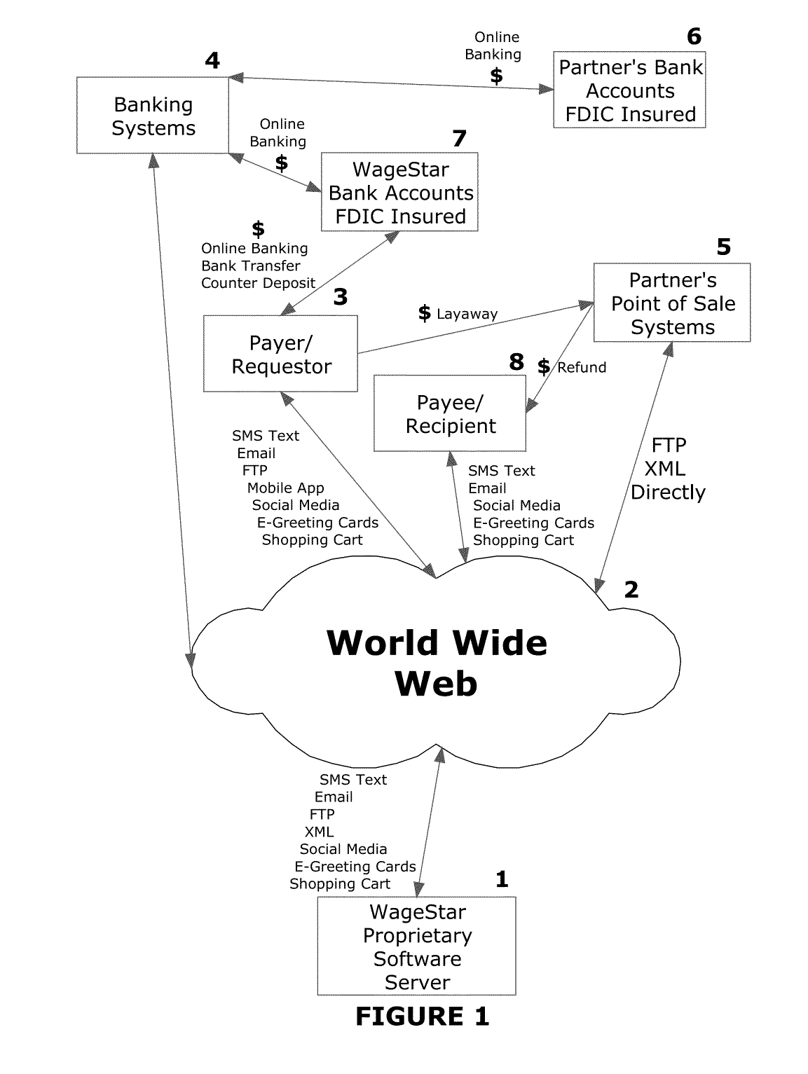

In FIG. 1, is a functional block diagram of the invention, highlighting the interrelation between the proprietary host server hosting the software for this invention and the ultimate users of the system.

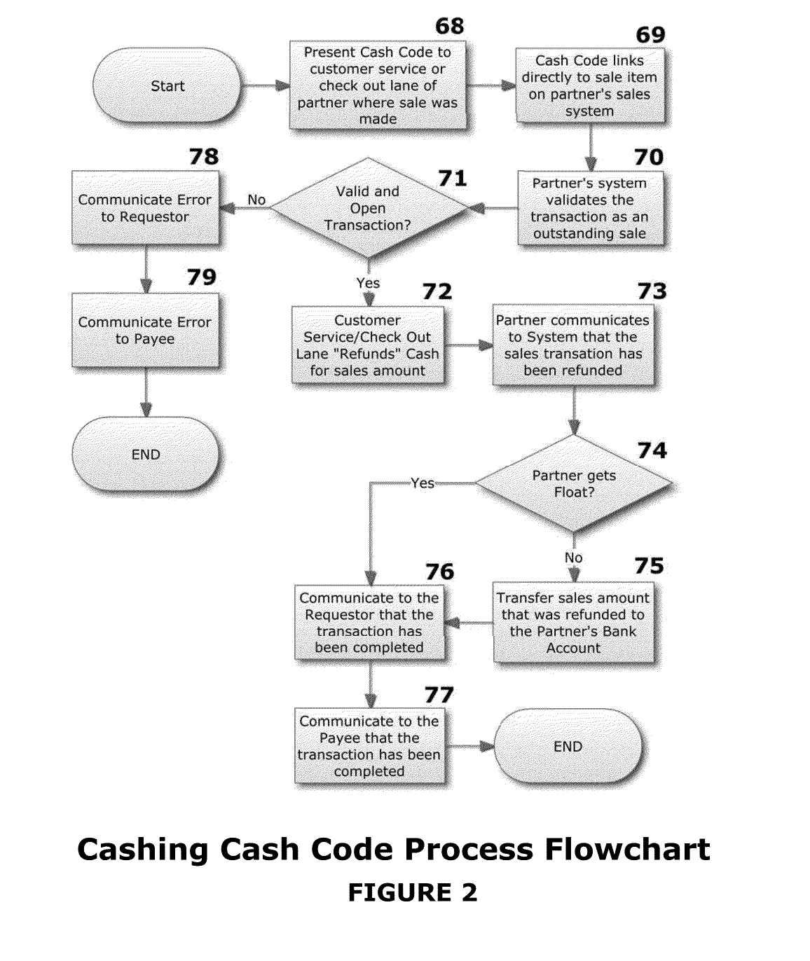

In FIG. 2, is a process flow diagram showing the flow between the recipient presenting the cash code to the retailer and the funds.

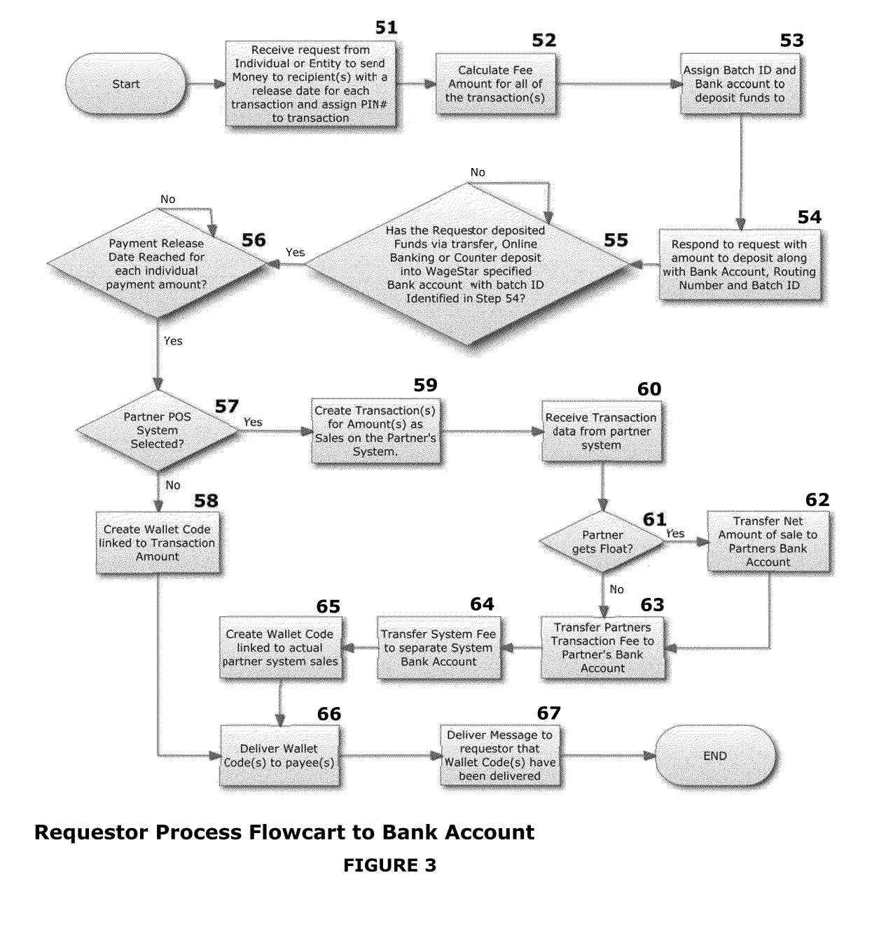

In FIG. 3, is a process flow diagram that details the relationship between the depositor of the funds and the retailer and the ultimate recipient.

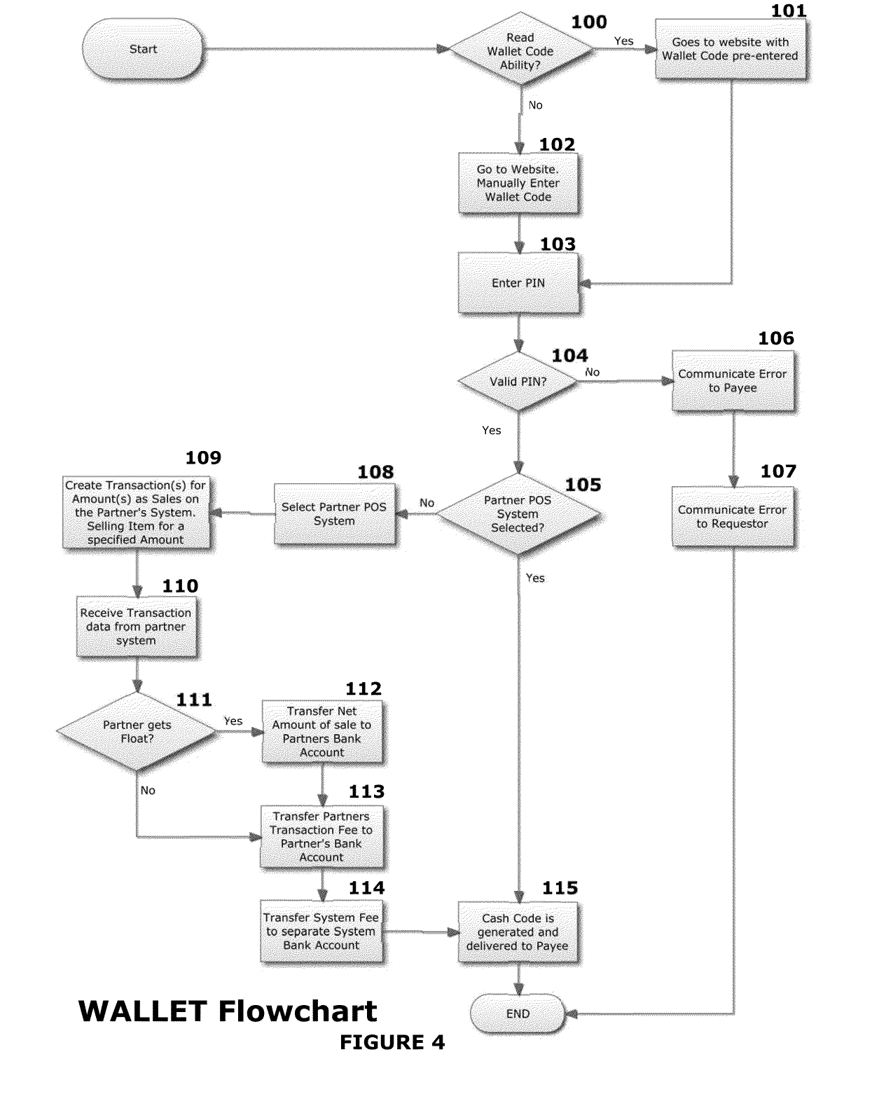

In FIG. 4, is a process flow diagram of the “wallet” system where validation takes place by the recipient.

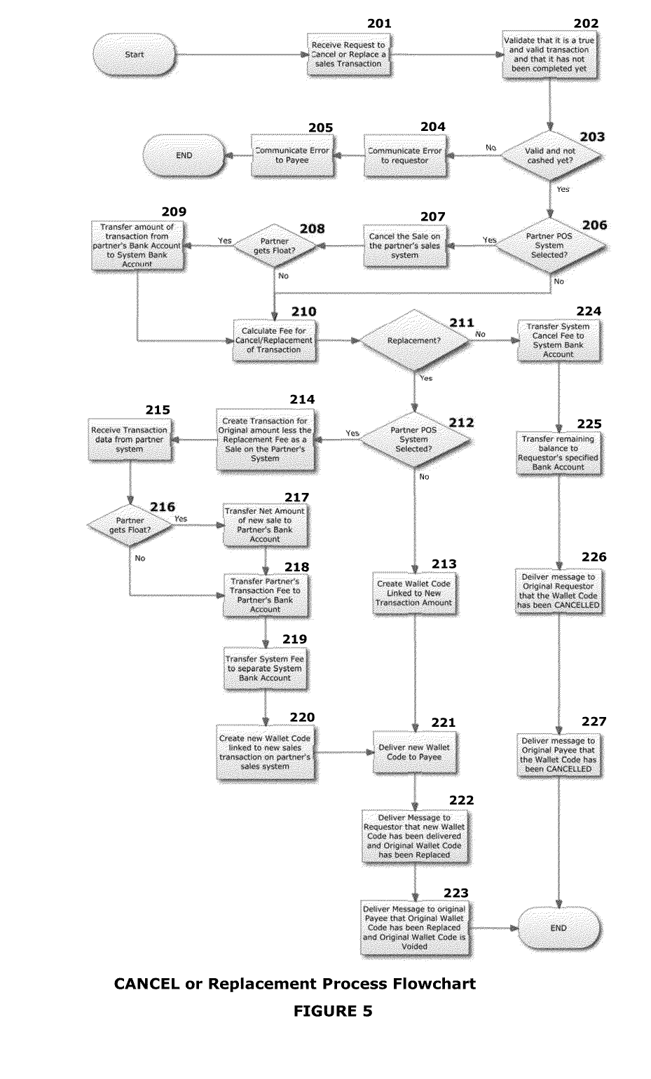

In FIG. 5, a process flow diagram of a cancel and/or replacement of the transaction is detailed.

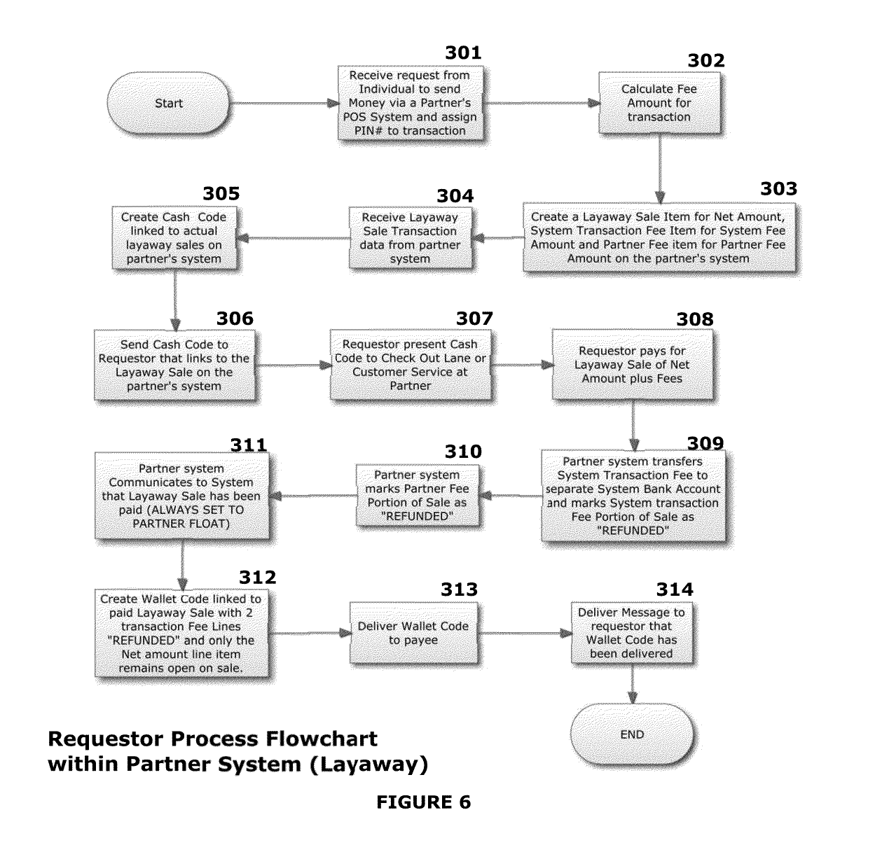

In FIG. 6, a process flow diagram showing an embodiment to the invention which uses the layaway function of the point of sale system to record a credit transaction.

### DETAILED DESCRIPTION OF THE INVENTION

This invention as disclosed in the drawings has the principle use in the retail store environment but there exists no limiting language to prevent this invention to be practiced in other fields of use. The invention consists of three main primary elements; 1) the creation of a requester code, based upon an amount of money deposited and selecting an establishment where the money will be received, such as retail vendor, 2) the money being deposited into the selected establishment's accounting system as a “sale” or any credit transactions, and 3) the process of “refunding”, or any debit transaction, the money to the requester along with the appropriate financial institutions interface. The term establishment refers to a company, store, kiosk or any vendor that 1) receives and has the capability to dispense funds in terms of money or currency and 2) has an accounting system which can process sales/credit and returns/debits of products. This accounting system is sometimes referred as a point of sale (POS) system or point of purchase (POP) system, but can also include those establishments that only transact business through the receipt and disbursement of money, such as services like Western Union, Banking Institutions and Check Cashing companies. Throughout this disclosure the term POS or point of sale is used, as it is an acceptable industry term, whose application is described herein, but does not limit this application to only POS/retail establishment or vendors. POS refers to any type of accounting system where sales/credit and returns/debits are kept track of and recorded. The term sale or credit is used in this circumstance to refer to the receiving of money by the vendor/establishment in exchange for a product or service. The term return, refund or refunding and debits, used in this circumstance in this application refers to any system of a vendor whereby money is returned to a person who has previously created a credit on the vendor's system, either through a sale, layaway or by some other means. This application has the three primary elements and the best mode for practicing this invention is seen in the retail sales environment, in particular the larger retail or “big box” stores. This application of the best mode for practicing this invention is not a limiting factor in this invention. The primary elements are basic to the accounting structure of any establishment that processes credits and debits and that interfaces with the public and interfaces with financial institutions.

In the process of the money being deposited, the service will escrow the amount of fees that are due to the host system for providing the service and that are due to the retailer who is providing the service to the customer. This example of the best mode for practicing this invention is shown in the retail environment, especially suitable for the “Big Box” retailers, but is no way limited in it's scope or breadth to only those type of stores or only to stores that possess a POS system, This invention details the use of a credit transaction where money is being deposited into the financial system of another and then creating a debit transaction on the host system, allowing a party to receive the deposited money. The system is very similar in scope as a payroll direct deposit system, where an employer is depositing payroll money and the bank is crediting a person's bank account, and that person is able then to withdraw money or debit his bank account and receive his money. This invention is using a non-banking institution to complete the transaction, where the consumer would be naturally maintaining a relationship, such as the grocery store or the hardware store. Throughout this disclosure the name of the establishment that is disbursing the funds to the ultimate recipient is referred to as a retailer, retail store or vendor and all of the terms are merely inclusive of all institutions and establishments that could be used to disburse the ultimate money to the recipient that the requester had requested and paid for. The terms are not exclusive, as this invention can be used over a myriad of establishments, retail, wholesale, restaurants, utility companies just about anywhere money is used as a tender.

As seen in FIG. 1, the proprietary software, located on the host's networked computer software server system 1, interfaces with the requester 3, the payee 8, and the banking systems 4 through interfaces in the World Wide Web 2, a global system of interconnected computers and networks. The person requesting the money, the requester 3, can be either the ultimate receiver of the money, as in a payroll application where the requester has his payroll directly deposited into system 1 or can designate a third-party to whom the funds are to be paid, payee or recipient 8. The requester 3 will communicate to the software server system 1 through various translational means including pre-existing contractual obligations for direct deposit of funds, electronic mail, mobile applications that are on mobile phones, social media, text messaging, often referred to as SMS text messaging, E-greeting cards which are available through various third-party services on the World Wide Web, and the normal shopping cart, which is available again through many third-party applications and sites. It is foreseen that retailers will use on-line transactions that will use the shopping cart function to allow a recipient to receive, or use, the funds due to them. The requester 3, transfers money/funds, or has money/funds transferred that is due to him, to the systems bank account 7, through a variety of financial transmission means, such as but not limited to, online banking, bank or direct deposit, or deposits through various payroll systems, and/or directly from the employer or manual counter deposits at various institutions that are part of the system. The server's system validates that the funds received match the funds transmitted and confirms that the funds are of valid tender for the ultimate vendor's system along with any Federal Regulatory compliance that may be necessary. The systems bank account 7 relates to partners bank account 6 through the current system of linking all major financial institutions 4 through online banking relations. As can be seen software server 1, upon verification of financial deposits, will also speak directly to the partners point-of-sale systems 5, thereby creating the “sales” or credit transaction that is the basic concept for the system. The “sales” transaction occurs in the partners point-of-sale system whereby the payee 8, will receive the money from the partners point of sale system. The software server 1, communicates with payee 8 through text messaging, electronic mail, social media, e-greeting cards, shopping carts, or through traditional paper methods that their money is available at the partner's establishment. The partners point-of-sale system 5 will communicate to software server 1 upon the completion of the “sale”. The point of sale system creates a “refund” or debit on the partners point-of-sale system 5 when the payee either approaches the Partner through a customer service “refund” transactions or more preferably, the payee goes to the partner and shops at the store and uses the “refund” amount to purchase goods from the partner store.

The basis for the system is the matrix barcode. It represents the confirmation that an amount of money has been deposited and that a partner has been selected to receive the money. FIG. 3 shows the flow from when the system 1 receives a request from a requester 3 to release money to a payee or recipient 8 with release dates for each transaction. This transaction 51 is the start of the process. The system 1 then calculates the fee 52 which the server shall receive based on the amount of money the requester is to deposit. The system then assigns a Batch ID 53 to the transaction and determines which bank account belonging to the system 1, where the funds will be deposited. It is a function of the system to ensure that no one bank account will receive more money than can be properly insured. The system responds with 54 a request to deposit the money from requester to the appropriate bank account using online banking, bank transfers, manual counter deposits, or direct payroll and or direct deposit deductions, identifying this transaction with a transactional identification code or batch ID. A check for 55 to confirm that the funds have been deposited and that a batch ID 53 has been properly assigned the system then checks to find if the release date has been obtained for the transaction if the request for funds is not for immediate disbursement. It is possible with this system to have multiple release dates and as the system checks for release dates 56 this system will also check to determine if there are sufficient funds for the release on the particular release date. Upon the system 1 being able to verify that funds are available and that they have been properly identified and deposited then checks to see if a partners POS system has been selected 57. If the POS system has been selected 57 then the system communicates with the partners POS system and creates a “sale” or a credit on the partners POS system for the amount of money that the requester has deposited, minus any fees paid to the system and any fees that the partner has chosen to collect for the transaction. At this point, the system creates a wallet code 58, which is a matrix barcode that represents the transaction, including the Batch ID code and any other pertinent information. A wallet code 58 is not useable at the vendor until it is verified using a personal identification code that is communicated to the recipient by the requester as shown in FIG. 4.

If a particular partner has been selected by the requester, a transaction is created on the partner's POS system once the partner receives the data transaction 60 from the system. The system then decides whether the partners bank account shall immediately receive the deposited money or should the system wait until the payee or recipient 8 completes the transaction. This decision on float 61 is a contractual obligation based upon the partners and the host systems 1 relationship. Should the system 1 keep the money, and take advantage of the float 62 then this system transfers any of the partners fees that are due to them 63 into the partners bank account. Furthermore, the host system 1 will collect its fee 64 and transfer it to the systems own bank account. The resulting transaction creates a wallet code in 58 that now also contains vendor information at this point, which is represented by the matrix barcode 66 and the system then sends a message to the requester 67 that the transaction has been completed and that the recipient of the funds can now access those funds upon verification. The matrix barcode 66 can be transmitted to recipient 8 through a variety of means such as SMS test messaging or electronic mail, or a variety of other sources so long as the matrix barcode is able to be presented to the partners POS system in a readable manner.

As detailed in FIG. 4, once the recipient receives the wallet code, the wallet code must be converted into a cash code. This is a level of security that is introduced into the system whereby those who should not have the wallet code are not able to take advantage of it. It is critical that the requester create a personal identification number (PIN) that is transmitted or communicated to the recipient in a means that is outside of the server system 1. In this matter only the payee or recipient will be able to have the pin number that will unlock the wallet code. When the recipient receives the wallet code he should be able to read the code directly using a mobile phone or other device or manually 100. If the recipient can read the received wallet code using a mobile phone or other device 100, the wallet code will automatically go to the server system 1 website with the wallet code pre-entered 101. If not, the recipient will need to go to the server system 1 website and enter the human readable wallet code 102. The recipient then enters the personal identification number (PIN) 103 into the system. Should the personal identification number not be correct, the system immediately communicates the error to the payee 106 and also communicates the error to requester 107 which will ensure or communicate at least to the requester that there is a problem with the personal identification number and the wallet code. Should the personal identification number be correct this system will then determine if a vendor has already been preselected 105. Should a partner already be selected as being the place where the recipient will receive his funds, a cash code is created 115 and is delivered to the payee in whatever manner the payee requires it to be communicated to him, electronic mail, SMS Text, or any other means he has selected. The cash code is in the same matrix barcode as the wallet code and contains all of the information related to the transaction in an encrypted form but the cash code 115 is a code that has been verified with the personal identification number that has been communicated by the requester to the recipient. This communication takes place outside of the system to increase security. There are many instances where a requester will not specify a specific vendor. One instance is where parent is sending money to his child at college, where the money can be used to pay for food, pay bills, or any other vendor that is part of the network. In this manner the parent can ratio out or ration the money that is to be intended for use by the student by selecting release dates and appropriate amounts for those dates. This way the student can pay bills and or buy groceries depending on his needs and the parent limits the amount of money that is available to the college student. The parent can also limit the scope of where the funds are to be used such as grocery stores or particular bills to be paid through the system. Upon the selection of a partners POS system 108 a transaction for the amount selected is reflected as a sale on the partner system 109 and will receive transactions data from a partner system to the server 1 that the transaction is on their system. The determination of whether the partner gets the float money 111 is determined contractually and is part of the host systems contract. If the partner gets the float 112 then all of the money that the requester has requested minus any fees is transferred to the partner's bank account. Should the partner not get the float on the money, the partner's fee is removed from the server's bank accounts 113 and provided to the partner's bank account and the host systems fee 114 is also transferred at that time. Until the actual cash has been “refunded” the money sits in the systems bank accounts 7 unless the partner receives the float on those funds, which would mean that the money has been transferred to the vendor bank account 6 and the vendor takes advantage of that money as float in their banking system. Upon receiving the cash code, the vendor's POS system will link directly to the actual sale in their POS system. At this point the cash code is generated and delivered to the payee as well 115.

As seen on FIG. 2 once the recipient 8 receives notification that the transaction has been completed 115, recipient 8 then goes to the vendor and either approaches the customer service department and presents the cash code generated in 115 and the recipient will receive his money in the form of cash. Another method is for the recipient 8 to visit the partner and shop for goods that are required and then present the cash matrix barcode at the POS system 68 and pay for his goods and receive any overage in cash. Upon receiving the transaction code the vendor's POS system will link directly to the matrix barcode presented and will then complete the cash sale. The vendors POS system will validate the code 70 by confirming that the transaction has not occurred in the past. As stated previously the matrix cash barcode is only good for one transaction. It is this single transaction feature that makes this system safe and unique. Should the system find through checking 71 that the code is not correct that it will communicate that error to their requester 78 and communicate the error to the payee as well 79. Should the transaction proved to be valid and open 71 then the recipient either receives all of the cash 72 or the amount of money that is due to him after he has purchased goods. The partner then communicates to the system that the sale has been completed 73, it is at that point the contractual relationship between the partner and system regarding float 74 is evaluated. Should the partner not get the float, then at this point the money that was deposited into the system's bank account is then transferred to the partners bank account 75. Should the partner get the float then they have already received the funds and shall communicate to the requester that the transaction has been completed 76 and then also will send a message to the payee or recipient 8 that the transaction has been completed 77.

FIG. 5 shows the process that is used when a matrix wallet or cash barcode that has already been generated needs to be canceled or replaced. As stated previously since the matrix barcode signifies a single use transaction, it is easily canceled as there are no calculations for remaining funds that are due. A request to cancel or replace 201 is received by the system which then validates that the code has not yet been used. If the code is valid and has not been cashed 203 within the system. The system then determines if the partners POS system had been selected in the previous transaction 206. Should it be found that the code is not valid or has been cashed 203 the system will then communicate that error to the requester 204 and ultimately to the payee 205. Should the partners POS system have already been selected 206 the system then sends out a cancellation of the sale based upon the transaction ID code to the partners POS system. The system will then determine whether the partner received the float 208, if so then the system will initiate a transfer of money from the partners bank account back to the system's bank account 209, and if the partner did not receive the float, then there are no funds to retrieve from the vendor. A cancel/replacement fee is calculated 210. The system responds to the requester's choice to replace the wallet code or cancel the wallet code 211. If replacement is no (cancel) then the system will transfer the cancellation fee to the system's own bank account 224. The system will then transfer the remaining balance back to the requester 225 minus the cancellation fee and will deliver a message to the requester that the particular matrix barcode has been canceled 226 and will also deliver a message to the payee or recipient that the transaction has also been canceled 227.

If replacement wallet code is requested 211 then the system will determine if a partners POS system had been selected 212. Should the partners POS system already be selected then the system will create a new “sale” 214 on the partners POS system in the amount that the requester had originally sent minus a replacement fee. Once the system confirms that the transaction data is in the partners system 215 the system determines who is getting the float 216. If the partner is getting the float, then the new amount is transferred to the partners bank account 217. The partner's banking receives the replacement transaction fee for the new sale from the system 218 and the system also collects it's replacement fee as well 219 and the system then creates a new wallet code 220 linked to the new sale created 214. If partner POS was not selected then the systems creates a wallet code 213, which is a matrix barcode that represents the transaction and any other pertinent information. There is now a new wallet code that is going to be transmitted in the means as listed before to the payee 221. The system will also deliver a message to the requester that a new wallet code has been created for the transaction and that the original wallet code has been replaced 222 and will also deliver a message to the original payee or recipient that the original wallet code has been replaced and that the new wallet code will need to be used, thereby avoiding the old wallet code.

An embodiment of the invention is shown in FIG. 6. Instead of using the banking system to receive funds, this embodiment uses the layaway function where the partner takes the place of the banking institution receiving the “sale” amount immediately into their system without the interface of a bank or any banking institution interface. Request 301 is received from the requester as in the principle system. The difference is that this request 301 is done directly into the partners POS system 5, where the POS system 5 will calculate the fees that are due to both the system and to the vendor in 302. The POS system 5 then creates the actual layaway sale 303 for the gross amount which is the requested amount plus the transaction fees. The POS system 5 then interfaces 304 with the server 1 and a transactional code is created that reflects the layaway sale on the partner system 305 at that point the code is then sent to the requester 306 where the requester now has the code that links the layaway sale to the requester's request for money. The requester or whomever the code is given to, presents the code to the check out or customer service at the partner 307 where the requester 308, pays the layaway sale using the code that was provided to him in 306. This is equivalent to the requester putting money into the bank as in 55 or equivalent to a requester putting money down as part of layaway program with a retailer, such as for holiday gifts. At this point, the partner transfers the system's fees from the vendors bank to the host system servers bank 309, and the partners fee is “refunded” back to the partner 310 and the system then communicates to the server that the layaway “sale” has been paid for 311. At this point the amount that the requester had originally requested is now available on the partners POS system 312 and is reflected in the partner's accounting system. All of the service and partner fees have been paid previously, as the fees are added to the original requester amount and paid for as a layaway sale. Once the money is paid by the requestor, the system “refunds” the system fee portion of the sale and the vendor fee portion of the sale. All that remains “open” or available is the original requester amount. At this point the system then communicates to the receiver 313 and provides them with the wallet barcode. A message is sent to the original requester that the wallet code has been delivered to the payee 314. As seen before with the wallet code in FIG. 4 now the payee or the recipient now converts the wallet code into a cash code using the personal identification number. This added portion of security allows the requester to assure that only the recipient or payee is able to access the wallet code because only that person will have the personal identification number that will allow him to convert it into a cash code. When the receiver goes to the vendor to receive the funds, the POS system creates a refund of the layaway amount in the accounting system, and the receiver receives the funds. It will refund the remaining sale amount. The amount of funds requested are treated as a layaway in the partner's accounting system until the funds are paid and then it is recorded as a sale in the partner's accounting system. The original layaway amount is the original amount of funds requested amount plus the system fee plus the vendor fee. At the time the requester pays the funds, which includes the amount requested plus fees, the partner's accounting system creates a layaway transaction and the system fee is refunded and the vendor fee is refunded so that the original requester amount is the only amount still open on the layaway sale. When the receiver collects his funds, it is treated as a refund that is equivalent to the remaining balance of the sale or layaway amount and the partner's accounting system reflects the transaction as a debit in their system.

It can be appreciated by those appropriately skilled in the art that changes, modifications or embodiments can be made to this invention without departing from the spirit, principles, theories, ideas or conceptions that have been disclosed in the foregoing. It is herein recognized that the embodiments disclosed by this description of the best mode of practicing this invention, which will be hereafter described in the claims and equivalents thereof.

What is claimed is:

1. A Method To Disburse Money Through a vendor's accounting system, said system capable of processing credits and debits, using the Refund/Return transactional function incorporated in said accounting system comprising;
i. providing a networked computer server system to host a service, said service involves a requester who requests the transmission of funds belonging to said requester to be retrieved by a receiver at a vendor, said requester using translation means to communicate said request to said server system;
ii. receiving said funds from said requester;
iii. establishing a server system bank account at a financial institution whereby said funds from said requester are deposited and where said funds are further awaiting disbursement to said vendor;
iv. providing a means to receive and evaluate said funds received from said requester into said bank account, escrowing service fees from said funds as payment for said service, and creating a transactional identification code unique to said request and transmitting said identification code to said receiver;
v. securing said transactional identification code by requiring said requester to communicate to said receiver a personal identification number, said communication being accomplished externally to said server system;
vi. notifying said vendor that said requester desires to retrieve their funds from said vendor;
vii. providing a means for said receiver to validate said transactional identification code with said personal identification number and creating a unique matrix identification barcode that contains all pertinent information necessary to complete said request in vendor's said accounting system regarding said transaction in an encrypted form;
viii. creating a transaction on said vendor's accounting system that is reflected as a credit sale corresponding to amount of said funds, said transaction being referenced by said unique matrix identification barcode;
ix. allowing for said receiver to access said funds at said vendor by said receiver presenting said unique matrix identification barcode to said vendor for a single transaction whereby said receiver receives said funds at one time, thereby causing said vendor's accounting system to create a debit transaction through the refund process that is incorporated into said vendor's accounting system;
x. allocating said escrowed service fees to said vendor and said service; and
xi. recording completion of said single transaction that incorporates said unique identification barcode in said vendors accounting system and notifying said receiver and said requester that the transaction is complete through said transmission means.

2. A Method To Disburse Money as in claim 1 where said funds awaiting disbursement are disbursed to said vendor upon said creation of said credit sale transaction on said vendor's point of sale system.

3. A Method To Disburse Money as in claim 1 where said funds awaiting disbursement are disbursed to said vendor upon said creation of said debit sale transaction on said vendor's point of sale system.

4. A Method To Disburse Money as in claim 1 where said translational means for a requester to request the transmission of funds includes contractual obligations of requestor and receiver, electronic mail, SMS Text Messaging, social media, mobile phone applications, gift cards and shopping cart and where said request includes the amount of funds to be transmitted, at least one date of release corresponding to said amount of said funds and a personal identification number.

5. A Method To Disburse Money as in claim 4 where said request includes the selection of at least one partner vendor at time of request.

6. A Method To Disburse Money as in claim 4 where said request does not include the selection of at least one partner vendor at time of request.

7. A Method To Disburse Money as in claim 6 where said receiver selects at least one partner vendor at time of validation.

8. A Method To Disburse Money Through a vendor's accounting system, said system capable of processing credits and debits, using the Layaway transactional function incorporated in said accounting system comprising;
i. providing a networked computer server system to host a service, said service involves a requester who requests the transmission of funds belonging to said requester to be retrieved by a receiver at a vendor, said requester using translational means to communicate said request to said server system;
ii. providing a means for said receiver to validate said transactional identification code with said personal identification number and creating a unique matrix identification barcode that contains all pertinent information necessary to complete said request in vendor's said accounting system regarding said transaction in an encrypted form;
iii. creating a transaction on said vendor's accounting system that is reflected as a credit sale through a layaway process corresponding to amount of said funds along with a prescribed service fee paid by said requester, said transaction being referenced by said unique matrix identification barcode.
iv. receiving said funds from said requester;
v. providing a means to receive and evaluate said funds received from said requester into said vendor's accounting system, escrowing said service fees from said funds as payment for said service, and creating a transactional identification code unique to said request and transmitting said identification code to said receiver;
vi. securing said transactional identification code by requiring said requester to communicate to said receiver a personal identification number, said communication being accomplished externally to said server system;
vii. allocating and transmitting said service fees to a bank account for said vendor and a bank account for said service;
viii. allowing for said receiver to access said funds at said vendor by said receiver presenting said unique matrix identification barcode to said vendor for a single transaction whereby said receiver receives said funds at one time, thereby causing said vendor's accounting system to create a debit transaction through the refund process that is incorporated into said vendor's accounting system;
ix. recording completion of said single transaction that incorporates said unique identification barcode in said vendors accounting system and notifying said receiver and said requester that the transaction is complete through said transmission means.

9. A Method To Disburse Money as in claim 8 where said translational means for a requester to request the transmission of funds includes contractual obligations of requestor and receiver, electronic mail, SMS Text Messaging, social media, mobile phone applications, gift cards and shopping cart and where said request includes the amount of funds to be transmitted, at least one date of release corresponding to said amount of said funds and a personal identification number.
